(19) United States
(12) Patent Application Publication
(10) Pub. No.: US 2025/0273700 A1
(43) Pub. Date: Aug. 28, 2025

(54) MULTI-CELL FLOW BATTERY AND FUEL CELL ASSEMBLIES

(71) Applicants: Jonghyun Park, Rolla, MO (US); Hiep Pham, Rolla, MO (US); Ian Wolf, Rolla, MO (US)

(72) Inventors: Jonghyun Park, Rolla, MO (US); Hiep Pham, Rolla, MO (US); Ian Wolf, Rolla, MO (US)

(73) Assignee: The Curators of the University of Missouri, Columbia, MO (US)

(21) Appl. No.: 19/200,247

(22) Filed: May 6, 2025

Related U.S. Application Data
(63) Continuation-in-part of application No. 17/506,123, filed on Oct. 20, 2021.
(60) Provisional application No. 63/169,551, filed on Apr. 1, 2021.
(60) Provisional application No. 63/093,849, filed on Oct. 20, 2020.

(51) Int. Cl. H01M 8/0252; H01M 4/88; H01M 4/96; H01M 8/0263; H01M 8/18

(52) U.S. Cl. CPC H01M 8/0252; H01M 4/8853; H01M 4/96; H01M 8/0263; H01M 8/18

(57) ABSTRACT

Multi-cell electrochemical reaction cell structure for a flow battery or fuel cell having a plurality of cells electrically connected in series or parallel. A first housing has a pair of mating end plates assembled together, each forming a plurality of recesses in which one of the cells is received. One of the end plates has a projection along its perimeter and the other one of the end plates has a groove along its perimeter. The projection is configured to fit within the groove in a mating relationship to seal the housing when the end plates are engaged with each other. A second housing is a tubular shell in which a plurality of tubular flow cell units electrically connected in parallel are housed. Catholyte flows in the tubular flow cell units and anolyte flows in the tubular shell.

### CROSS-REFERENCE TO RELATED APPLICATIONS

This application is a continuation-in-part of U.S. patent application Ser. No. 17/506,123, filed Oct. 20, 2021, which claims the benefit of U.S. Provisional Patent Application No. 63/093,849, filed Oct. 20, 2020, and U.S. Provisional Patent Application No. 63/169,551, filed Apr. 1, 2021, the entire disclosures of which are incorporated by reference for all purposes.

### BACKGROUND

Aspects of the present disclosure relate generally to flow battery and fuel cell technologies.

Conventional flow batteries include a cathode, an anode, a membrane separator, current collectors, gaskets, insulators, and reaction cells within a confined volume, such as within channels of a bipolar plate. All of these components must be carefully compressed between two end plates. The bipolar plate, also called a flow-field plate, distributes an electrolyte solution inside flow battery cells, isolates different cells in multi-cell battery cores, conveys current into and out of cells, and dissipates the stack heat. The main role of the bipolar plate is to deliver reactants to and from porous anode and cathode materials via flow field channels.

Fuels cells are a promising carbon-neutral and sustainable power source for portable, mobile, and stationary applications. In general, a conventional fuel cell comprises an anode, a cathode, and an electrolyte. The fuel cell includes first and second housing sections, or end plates, assembled together via a plurality of mechanical fasteners, such as bolts. An anode fuel inlet supplies hydrogen fuel to one electrode (the anode) where it is oxidized to release electrons to the anode and hydrogen ions to an electrolyte. A cathode fuel inlet supplies oxidant (typically air or oxygen) to the other electrode (the cathode) where electrons from the cathode combine with the oxygen and the hydrogen ions in the electrolyte to produce water.

Fuel cells convert chemical energy generated from oxidation of hydrogen into electric energy. In operation, the cell processes a hydrocarbon fuel source to produce the hydrogen. Liquid hydrocarbon fuel sources offer high energy densities and the ability to be readily stored and transported. Because fuel cells have a higher efficiency compared to internal combustion engines, and are substantially free from emission of pollutants, they have garnered attention as an alternative energy technology.

In the conventional fuel cell, the housing contains flat flow field channel blocks or plates designed to provide an adequate amount of a reactant (hydrogen or oxygen) to a flat membrane electrode assembly (MEA) sandwiched between the plates. Each MEA in a stack is sandwiched between two flow field plates to separate it from neighboring cells, similar to flow batteries. The flow field plates, also referred to as bipolar plates, are typically formed of metal, graphite, or a carbon composite to permit good transfer of electrons between the anode and the cathode. Gaskets provide a seal around the MEA to help prevent leaks between the MEA and the flow field plates.

In conventional stacked structures for both fuel cells and flow cells, components such as the electrodes, bipolar plates, and gaskets are exposed at the edges, causing significant challenges with electrolyte leakage and subsequent performance loss. Stacking of cells yields higher voltages but exacerbates leakage issues, as the channels to deliver the electrolyte to each cell are also exposed. To address these challenges, work has been done to develop a better seal between components, such as the addition of rubber seals and polymer fittings to a unit cell design, which can allow higher compression between the components. Nevertheless, leakage remains a significant challenge because cell components remain exposed and the end plates are graphite-based.

Among the energy storage technologies, redox flow batteries (RFBs) have gained prominence, presenting significant advantages including enhanced safety, durability, decoupled power/energy characteristics, and promising affordability. However, two significant limitations confront current RFB technologies: the chemistry of RFBs and their system-level manufacturing, installation, and maintenance.

For instance, vanadium redox flow batteries (VRFBs) are a popular technology in the realm of RFBs, utilizing vanadium's distinct property to exist in four oxidation states. This property helps mitigate performance degradation caused by crossover effects in RFBs. While VRFBs have demonstrated promise in large-scale demonstrations, challenges persist due to the scarcity and price volatility of vanadium. As an alternative, iron redox flow batteries (Fe-RFBs) utilize abundant iron as the redox active material. However, conventional Fe-RFBs face limitations such as incomplete decoupling of power and capacity, which poses challenges like limited duration and dendrite formation.

In commercial deployment, flow battery technology faces several challenges in both component manufacturing and system-level design. Components such as membranes, electrodes, and electrolytes lack scalability and manufacturability, leading to increased costs and limited production scale. Membrane improvements are particularly critical for enhancing the scalability and production efficiency of high-performance flow battery systems. Moreover, flexibility in manufacturing processes is necessary to optimize components for various battery designs and chemistries. At the system level, challenges include slow and sporadic manufacturing of flow battery systems in the U.S., necessitating improvements in development rates.

### SUMMARY

Aspects of the present disclosure focus on developing well performing redox flow batteries and fuel cells comprising multiple high voltage cells to increase their energy output. The disclosed multi-cell structure addresses the issues in stacking cells by embedding all components within the end plates and eliminating the need for several gasket components thus protecting the structure, lowering the effective weight of the cells, and eliminating safety concerns. Aspects of the present disclosure further incorporate multiple cells into a single design to achieve a high voltage redox flow battery or fuel cell.

Moreover, aspects of the present disclosure address several key challenges associated with conventional flow battery systems, improving their efficiency, reliability, and scalability. Traditional flow batteries often suffer from stacked structure limitations, leading to increased leakage risks, inefficient electrolyte flow, and constrained installation options. A redox exchange flow battery (REFB) in accordance with one or more embodiments overcomes these issues with a heat-exchanger-type design that optimizes electrolyte distribution, minimizes leakage, and enhances durability. Additionally, membrane integrity and fabrication complexity are major concerns in conventional systems, where flat membranes may degrade over time due to mechanical stress and uneven ion transport. The closed-shape membrane synthesis described herein ensures better structural stability, controlled wall thickness, and extended operational lifespan. Furthermore, manufacturing constraints in traditional flow batteries limit design flexibility and increase production costs. By incorporating additive manufacturing techniques, aspects of the present disclosure enable rapid prototyping, customized geometries, and efficient material utilization, which in turn revolutionizes flow battery production. Overall, the innovations described herein provide a more versatile, durable, and efficient energy storage solution that enhances deployment flexibility and long-term performance.

In an aspect, a multi-stack fuel cell comprises a plurality of electrochemical reaction cells electrically connected in series. The reaction cells each comprise an anode electrode and a cathode electrode. The fuel cell also comprises a housing having a pair of mating end plates assembled together. The end plates each have a recess formed in an inner surface thereof in which the plurality of reaction cells are received. The housing also contains an electrolyte fluid in contact with the electrodes.

In another aspect, a multi-stack flow battery comprises a plurality of flow cell units electrically connected in series and a housing. The housing has a pair of mating end plates assembled together, each of which has a plurality of recesses formed in an inner surface thereof. The recesses each receive one of the flow cell units. One of the end plates has a projection along a perimeter of each of the recesses and the other one of the end plates has a groove along a perimeter of each of the recesses. The projection is configured to fit within the groove in a mating relationship to seal the housing when the end plates are engaged with each other.

In another aspect, a multi-stack electrochemical reaction cell structure for a flow battery or fuel cell has a plurality of cells electrically connected in series and in fluid communication with each other. The cells each comprise an anode electrode and a cathode electrode and an electrolyte fluid in contact with the electrodes. A housing has a pair of mating end plates assembled together, each forming a plurality of recesses in which one of the cells is received. One of the end plates has a projection along a perimeter of each of the recesses and the other one of the end plates has a groove along a perimeter of each of the recesses. The projection is configured to fit within the groove in a mating relationship to seal the housing when the end plates are engaged with each other.

In yet another aspect, a multi-stack electrochemical reaction cell structure includes a plurality of tubular cells electrically connected in parallel and in fluid communication with each other. Each cell has an electrode and a corresponding membrane. The cell structure also includes a tubular housing in which the tubular cells are positioned, a catholyte fluid contained within each of the tubular cells and in contact with the electrode thereof, and an anolyte fluid contained within the housing and in contact with the catholyte fluid at the membrane of each of the tubular cells.

In an aspect, an electrochemical reaction cell assembly comprises a housing, at least one tubular cell unit positioned within the housing, and first and second electrolyte fluids contained within the housing. The tubular cell unit comprises an inner current collector and an outer current collector arranged concentrically with respect to the each other within the tubular cell unit. In addition, first and second electrodes are positioned between the inner current collector and the outer current collector. The tubular cell unit further comprises a membrane separating the first and second electrodes from each other. The first and second electrolyte fluids have oppositely charged ions relative to each other and are in contact at the membrane.

In another aspect, a multi-cell assembly comprises a plurality of redox exchange flow batteries, each comprising a tubular housing and at least one tubular cell unit positioned within the housing. The tubular cell unit comprises an inner current collector and an outer current collector arranged concentrically with respect to the each other within the tubular cell unit. An anode and a cathode are positioned between the inner and outer current collectors. The tubular cell unit further comprises a membrane separating the anode and the cathode from each other, a catholyte fluid contained within the housing and in contact with the cathode, and an anolyte fluid contained within the housing and in contact with the anode. The inner current collector defines an inner flow channel through which the anolyte fluid flows in contact with the anode and the catholyte fluid flows within the housing around the tubular cell unit in contact with the cathode.

Other objects and features of the present disclosure will be in part apparent and in part pointed out herein.

### BRIEF DESCRIPTION OF THE DRAWINGS

FIGS. 1A and 1B are schematic diagrams of a male end plate and a female end plate, respectively, of an embedded, multi-cell flow battery according to an embodiment.

FIGS. 2A and 2B are schematic diagrams of an anode side and a cathode side, respectively, of an embedded stacked fuel cell according to an embodiment.

FIG. 2C illustrates an exploded assembly of the embedded stacked fuel cell of FIGS. 2A and 2B, including corrugated electrodes.

FIG. 3 illustrates a wrapped catholyte tubing structure having flow and active areas for an embedded, parallel stacked design according to an embodiment.

FIG. 4 illustrates a heat-exchanger type REFB according to an embodiment.

FIG. 5A is an exploded view of the REFB of FIG. 4 according to an embodiment.

FIGS. 5B and 5C illustrate internal components of the REFB of FIG. 4 according to an embodiment.

FIG. 6 illustrates an example of a module assembly having a plurality of standardized REFB units connected to each other according to an embodiment.

Corresponding reference characters indicate corresponding parts throughout the drawings.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

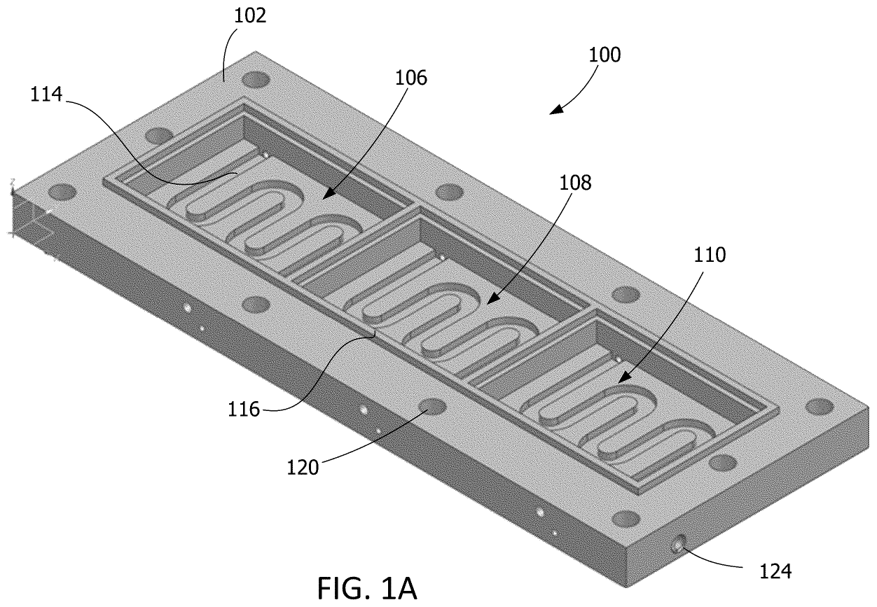

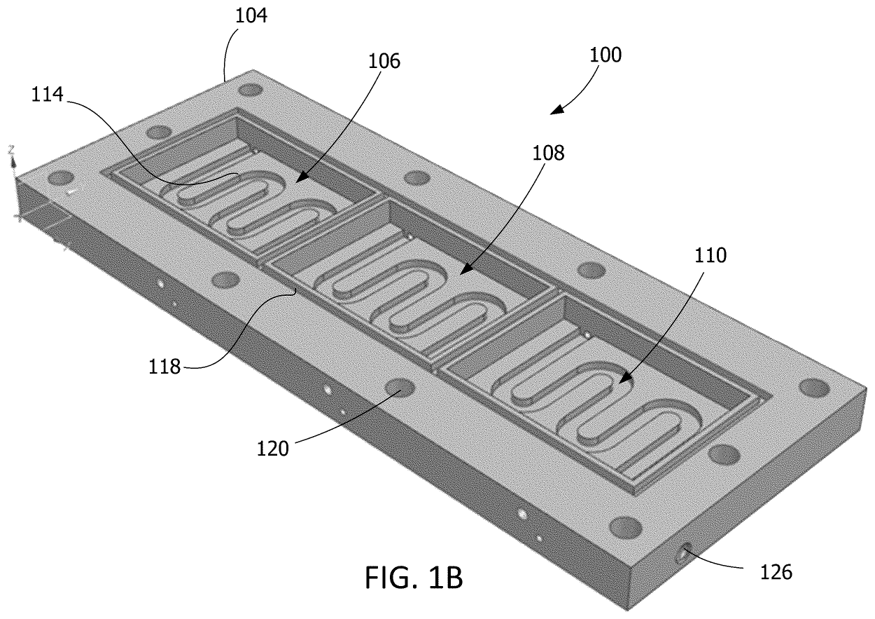

Referring to the drawings, FIGS. 1A and 1B show a multi-cell embedded structure for a flow battery 100. The flow battery design, which resembles a plate heat exchanger in accordance with embodiments of the present disclosure, enables serial connection of multiple cells to increase the voltage of the flow battery 100 and thus increase its power. A first end plate 102 mates with a second end plate 104 to form a housing. In the illustrated embodiment, each of the end plates 102, 104 features three compartments 106, 108, 110 formed in an inner surface of the end plates and defined by a plurality of recess walls.

When end plates 102, 104 are assembled together, each of the compartments 106, 108, 110 defines one reaction cell of battery 100. Within each of the compartments 106, 108, 110, a flow channel 114 is etched into end plate 102 in, for example, a serpentine pattern. Similarly, the end plate 104 features three corresponding compartments 106, 108, 110 etched with the corresponding flow channel 114. It is to be understood that the design of flow battery 100 could be scaled to accommodate any number of individual cells. In addition, it is to be understood that flow channel 114 may be formed in other patterns and have other dimensions within the scope of the present disclosure.

The first end plate 102 and the second end plate 104 are configured to contain and protect the components of multiple reaction flow cells corresponding to the compartments 106, 108, 110 when the end plates are mated together to form a housing. The end plates 102, 104 may be manufactured from any rigid material compatible with the electrolytes. For example, the rigidity of first end plate 102 and second end plate 104 obviates the need for external or separate end plates and the compatibility with the electrolytes obviates the need for insulators. In an embodiment, end plates 102, 104 are manufactured from a thermoplastic, such as polyvinyl chloride (PVC). Exemplary advantages of PVC include light weight, good mechanical strength, impermeability, and resistance to weathering, chemical rotting, and corrosion. Furthermore, PVC can be cut, shaped, and joined in a variety of configurations.

When assembled, a male tongue 116 of end plate 102 mates with a female groove 118 of end plate 104 to form a seal. In an embodiment, end plates 102, 104 are bolted together through plurality of bolt holes 120 distributed about an outer margin of the end plates to ensure sealing during cell operation. In an embodiment, mechanical fasteners such as bolts are configured to mechanically join first end plate 102 and second end plate 104 into a single housing assembly. Although embodiments described herein utilize bolt fasteners, one of ordinary skill in the art will understand that other mechanical fasteners are within the scope of the present disclosure. Exemplary mechanical fasteners include, but are not limited to, clamps, clips, pins, rivets, screws, staples, and the like. Moreover, one of ordinary skill in the art will understand that end plates 102, 104 may be mechanically joined by alternative means. Exemplary means for joining the end plates include, but are not limited to, crimping, welding, soldering, brazing, taping, gluing (or other adhesives), cementing, and the like. Additionally or alternatively, first end plate 102 and second end plate 104 may be joined with by magnetic force, vacuum force (e.g., suction cups, etc.), friction force, and the like. In the various embodiments, the male tongue 116 of end plate 102 mates with the female groove 118 of end plate 104 to form a seal.

The reaction flow cell contained by each compartment 106, 108, 110 is configured to provide an environment through which electrolyte fluids flow, resulting in ion exchange that provides a flow of electric current. Each cell of battery 100 has at least a pair of electrodes separated by a membrane positioned within a recess defined by each compartment 106, 108, 110. In an embodiment, conductors (not shown) extend from the reaction flow cells. The conductors are configured to carry electrical current from the reaction flow cells to electrical contacts connected to an electrical load (e.g., of a transport system, etc.).

A tank or reservoir (not shown) supplies an anolyte to compartments 106, 108, 110 of end plate 102 via a flow inlet 124. Similarly, another tank or reservoir (not shown) supplies a catholyte to compartments 106, 108, 110 of end plate 104 via a flow inlet 126. The inlets 124, 126 are configured for fluidly communicating electrolyte fluids from corresponding tanks to the flow cells. An exemplary anolyte includes vanadium electrolyte solution (V+2, V+3) and an exemplary catholyte includes vanadium electrolyte solution (V+5, V+4). The flow inlets 124, 126 are internal channels within end plates 102, 104, respectively, configured to provide electrolyte to each compartment 106, 108, 110 when the end plates are assembled together. Supply tubes for inlets 124, 126 may be comprised of any polymer compatible with the electrolytes, such as PVC, polytetrafluoroethylene (PTFE), high-density polyethylene (HDPE), low-density polyethylene (LDPE), and the like. As described above, each compartment 106, 108, 110 contains the flow channel 114 (e.g., an etched serpentine flow pattern) and houses the components of a flow cell unit of battery 100.

In an embodiment, current collectors composed of stainless steel, graphite or carbon materials, or a mix of these materials, having the same serpentine flow pattern as flow channel 114 of end plates 102, 104, are placed into each compartment 106, 108, 110 and connected together in series by externally connecting the electrodes. Preferably, the serpentine flow pattern etched into end plates 102, 104 is uninterrupted by the separating dividers between compartment 106 and compartment 108 and between compartment 108 and compartment 110. Using the hybrid alkaline Zn-12 system as a demonstration, the open circuit voltage (OCV) of a test battery increased from a single cell voltage of 1.7 V to a multi-cell voltage of 4.2 V.

Aspects of a reaction flow cell for a battery are further described herein and in U.S. Pat. Nos. 10,367,221 and 11,031,619, the entire disclosures of which are expressly incorporated herein by reference, including the contents and teachings of any references contained therein.

Referring further to FIGS. 1A and 1B, flow battery 100 provides numerous advantages of conventional cell structures, which require numerous components such as porous graphite end plates having etched flow channels, two electrodes (the cathode and anode), a separator, current collectors, and gaskets and insulators. Furthermore, these numerous components of conventional cell structures are exposed from the end plates and require high compression and specific material selection to achieve both mechanical integrity and chemical resistance in order to operate properly. The complex design of conventional cells raises issues related to high weight (lowering gravimetric energy density), high space occupation (lowering volumetric energy density) and electrolyte leakage (lowering safety). Further, the stacking of cells compounds these issues. Aspects of the present disclosure overcome these challenges of conventional cell structures by embedding all components within end plates 102, 104, which has been etched with flow channels 114, and by incorporating multiple cells in a single assembly. In this manner, the number of components needed to stack individual cells and increase voltage is relatively small and advantageously uses a single set of current collectors for each cell to be added.

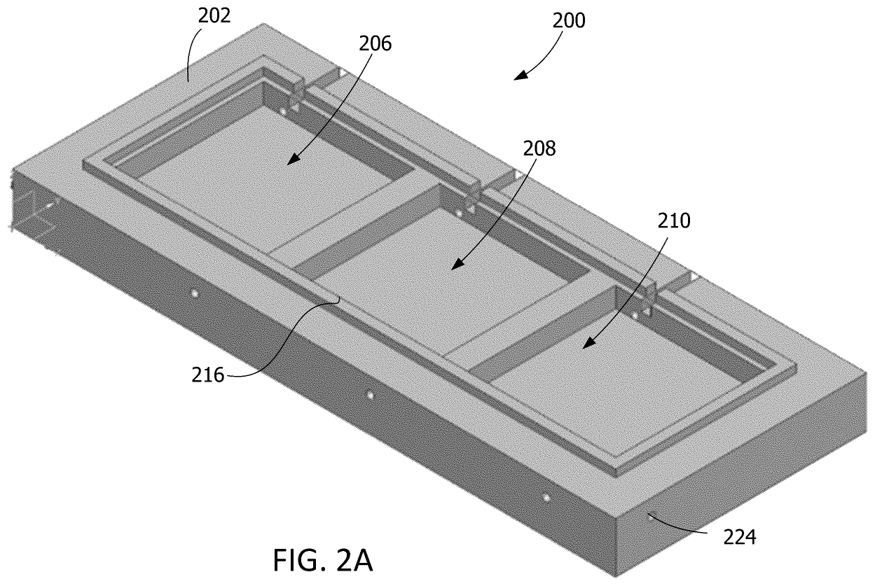

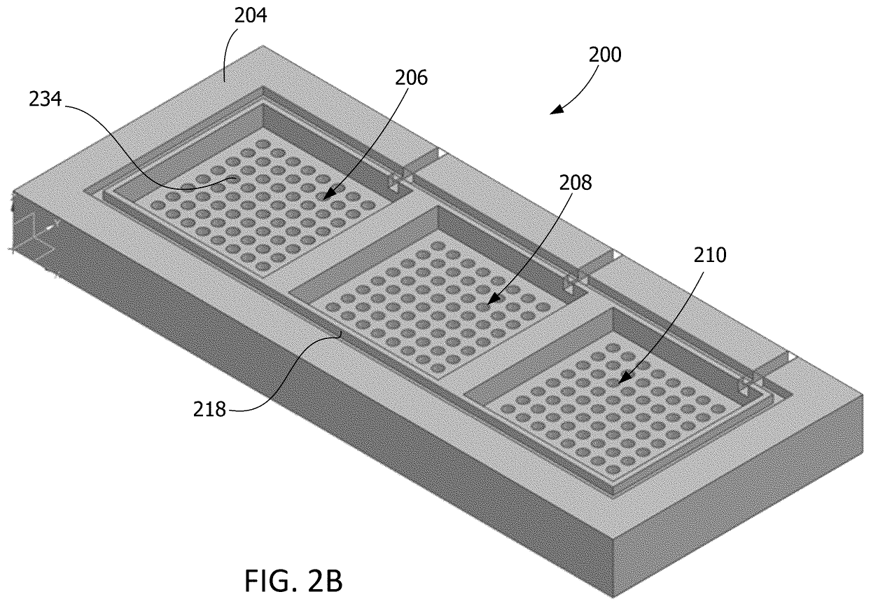

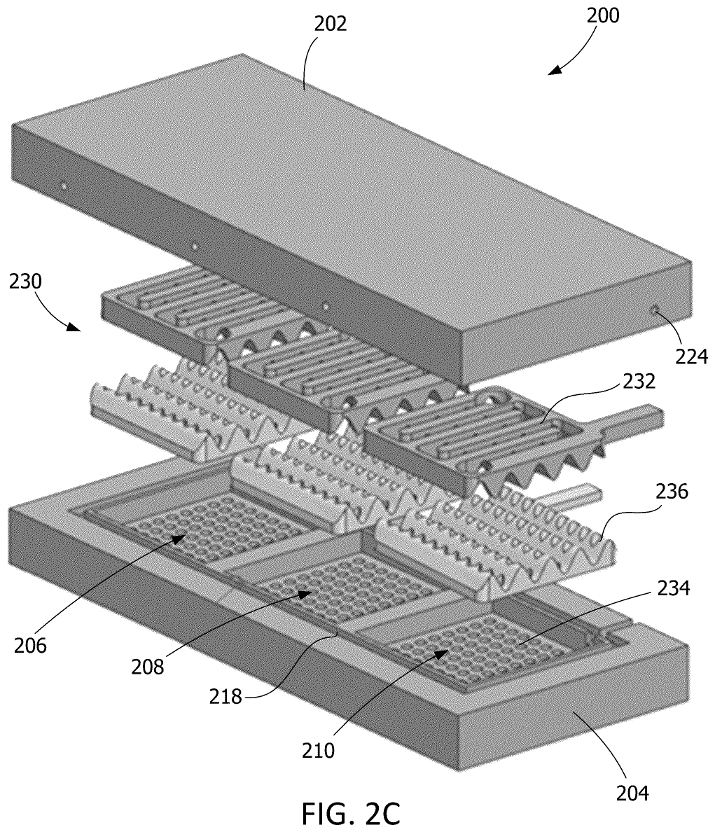

FIGS. 2A and 2B show a design for stacked embedded structures for a fuel cell 200, which resembles a plate heat exchanger in accordance with embodiments of the present disclosure. In FIGS. 2A and 2B, an embedded, series stacked design that can accommodate three fuel cell units is shown. Similar to the stacked design of flow battery 100, the stacked fuel cell 200 comprises a first end plate 202 that mates with a second end plate 204 to form a housing. In the illustrated embodiment, each of the end plates 202, 204 features three compartments 206, 208, 210 formed in an inner surface of the end plates and defined by a plurality of recess walls. When end plates 202, 204 are assembled together, each of the compartments 206, 208, 210 defines one fuel cell unit of fuel cell 200. It is to be understood that the design of fuel cell 200 could be scaled to accommodate any number of individual cells.

The first end plate 202 and the second end plate 204 are configured to contain and protect the components of multiple fuel cell units corresponding to the compartments 206, 208, 210 when the end plates are mated together to form a housing. When assembled, a male tongue 216 of end plate 202 mates with a female groove 218 of end plate 204 to form an impermeable seal. It is to be understood that end plates 202, 204 are configured to be joined together by various means without deviating from the present disclosure. A fuel inlet 224 to a manifold on the anode side delivers the fuel to each cell compartment 206, 208, 210. The cathode side contains holes to allow airflow for proper fuel cell operation.

FIG. 2C illustrates fuel cell 200 embodying further aspects of the present disclosure. When assembled, the components of the multiple fuel cell units of fuel cell 200 are housed within compartments 206, 208, 210. In this manner, the end plates 202, 204 obviate the need for gaskets. Referring further to FIG. 2C, fuel cell 200 includes a fuel cell membrane electrode assembly (MEA) structure 230 housed in each of the compartments 206, 208, 210 formed in end plates 202, 204. The MEA 230 includes an anode channel 232 and a cathode channel 234 across which an electrical load may be connected. In the illustrated embodiment, the cathode channel 234 is preferably formed in end plate 204. The MEA 230 further includes a membrane 236 sandwiched between anode channel 232 and cathode channel 234.

In the illustrated embodiment, the structures of MEA 230 have a matching corrugated shape, which increases the number of sites for the reaction to occur and thus increases the voltage relative to planar electrodes. Aspects of a fuel cell having a corrugated membrane electrode assembly are further described herein and in U.S. Pat. No. 11,380,926, the entire disclosure of which is expressly incorporated herein by reference, including the contents and teachings of any references contained therein.

Although the cross-sections of the reaction flow cells of FIGS. 1A and 1B and the fuel cell units of FIGS. 2A-2C described herein are substantially rectangular, one having ordinary skill in the art will understand that they may have different cross-sectional shapes, such as substantially square, circular, elliptical, triangular, hexagonal, octagonal, U-shaped, and the like.

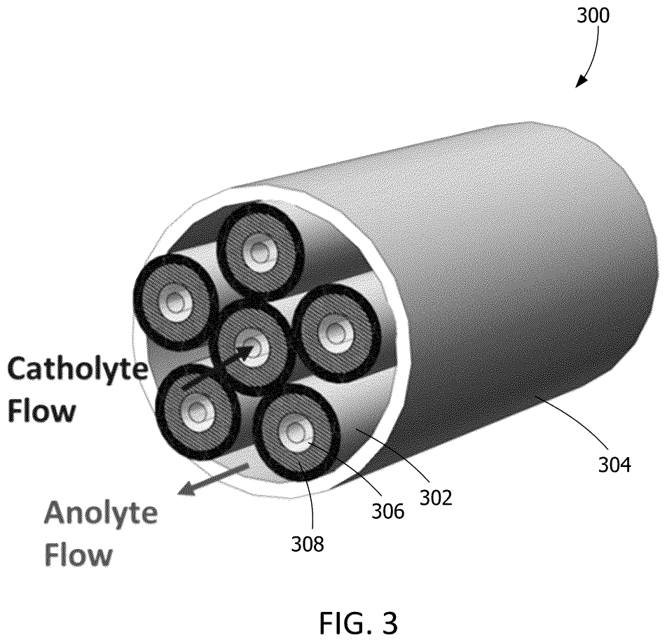

FIG. 3 illustrates aspects of an embedded structure stacked in parallel. In this instance, a flow battery 300 resembles a tube-in-shell heat exchanger, in accordance with an embodiment of the disclosure. In FIG. 3, a cross-sectional view shows multiple tubes 302 housed within a shell 304. Catholyte flows as shown through the tubes 302 and anolyte flows through the shell 304 around tubes 302. In an embodiment, catholyte tubes 302 have holes located radially along the length of each tube to permit transfer of the catholyte within the tubes through a flow cell carbon cloth electrode 306 and a membrane 308. As the catholyte flows through each tube 302, the anolyte is delivered through the shell 304 and meets the catholyte at the boundary of the carbon cloth electrode 306 and membrane 308 to allow the reaction to occur. Because there are numerous tubes which deliver the catholyte, the active surface area can be increased substantially compared to the conventional redox flow battery electrode of the same size, thereby increasing the power density.

To solve the challenges presented by known designs, aspects of the present disclosure utilize an embedded structure, wherein all of the components of the fuel cell or flow battery, including electrolyte flow channels, are embedded and then stacked, either in series or parallel configurations. These new embedded structures bear resemblance to plate heat exchangers when stacked in series and a tube-in-shell heat exchanger when stacked in parallel. In series, the embedded system encapsulates all components of the fuel or flow cell in a “pocket” structure which serves as the end plates. The pocket structure, itself, replaces the conventionally used graphite end plates with PVC which is impermeable, resistant to chemical corrosion, lightweight, more facile to machine, and cost-effective. The end plates are mated together by a male tongue/female groove that lies between the pocket and the bolt holes which hold the end plates together. The electrolyte/fuel is delivered through a manifold that lies within the end plate. By embedding the components and electrolyte/fuel delivery channels and implementing a male tongue/female groove, the leakage issue is eliminated and stacked cells which can achieve high voltage and performance are enabled.

In parallel, the embedded system encapsulates the components as numerous inner tubes wrapped by the cell components and an overall larger shell. The catholyte is delivered via the inner tubes, which are wrapped with the cell components, such as a porous current collector, membrane and electrodes. The numerous inner tubes are wrapped by a shell, in which anolyte is flowed through and makes the required contact with the catholyte at the membrane to facilitate the power and energy generation. This design is analogous to a “tube-in-shell” type heat exchanger and permits a very high surface area due to numerous tubes which comprise the design, thereby substantially increasing the power density.

In an aspect, a new cell structure design for redox flow batteries, an energy storage technology, overcomes the limitations of conventional cell structure designs. Generally, a typical redox flow battery cell design is composed of several exposed components which have issues such as high weight, high space utilization, and electrolyte leakage. As numerous cells are stacked together to increase the voltage output, these issues are exacerbated. Aspects of the present disclosure feature a pocket-like design that incorporates multiple cells into one assembly to improve voltage and energy output. Unlike conventional designs, which stack individual cells together, embodiments of the present disclosure connect cells in series internally into end plates with etched flow channels, eliminates several gasket components, and effectively lowers the overall weight of the battery.

In another aspect, high voltage fuel cells and redox flow cells are enabled by multiple cell stacking contained within one embedded structure, wherein all of the components and electrolyte/fuel delivery channels are embedded in a pocket structure composed of PVC end plates.

Further aspects of the present disclosure enable high voltage fuel cells and redox flow cells by encapsulating, or embedding, the components of the systems into a closed format and stacking them in series or parallel. A multi-cell structure embodying aspects of the present disclosure bears resemblance to various heat exchanger designs. In series, multiple cell stacking contained within one embedded structure, wherein all of the components and electrolyte/fuel delivery channels are embedded in a pocket structure composed of PVC end plates. In parallel, the system comprises numerous inner tubes flowing the catholyte that are wrapped with by the flow cell components (carbon cloth electrodes, membrane, etc.) and a flow of the anolyte in the outer shell.

It is to be understood that aspects of the present disclosure are applicable to other types of flow batteries and fuel cells and to reaction cells generally.

Aspects of the present disclosure address the issues in stacking cells by removing the need for several gasket components and by embedding all components aside from the end plates, protecting the structure, lowering the effective weight of the cells, and eliminating safety concerns. Furthermore, the present design incorporates multiple cells into a single design to achieve high voltages.

As described below, aspects of the present disclosure further improve flow battery system design and commercial deployment of RFBs by leveraging a novel iron flow battery chemistry. Preferred embodiments include (1) a heat-exchanger type design, featuring a tubular-shaped structure instead of conventional stacking; (2) modular systems for ease of assembly into larger configurations; (3) the use of metal-organic coordination compounds in aqueous RFBs to enable the use of pH-neutral or weakly basic electrolytes, replacing strong acidic ones; and (4) the use of additive manufacturing compatibility. Integration of these novel concepts achieves a low-cost, easily scalable, installation-friendly, leakage-resistant, and versatile system suitable for various applications.

The unique features set forth in the present disclosure enable the utilization of standardized and modular components, thereby facilitating easy scaling to meet diverse energy storage needs. Standardized modules streamline design and engineering processes, enhancing production scalability, reducing installation time, and cutting costs. Modular systems, with plug-and-play features, simplify connection, integration, and maintenance, contributing to operational efficiency. The flexibility to combine modules allows for customization to specific energy storage requirements. Furthermore, standardized and modular designs benefit from economies of scale, further reducing production costs and overall project expenses.

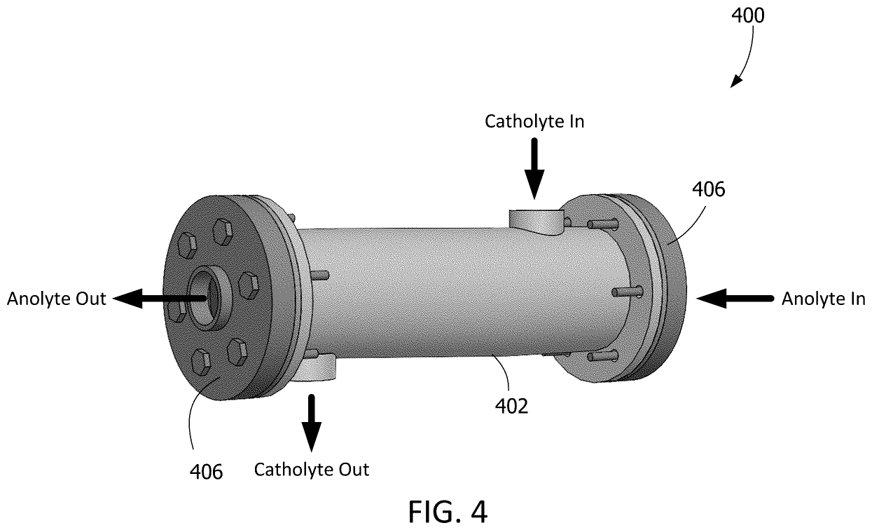

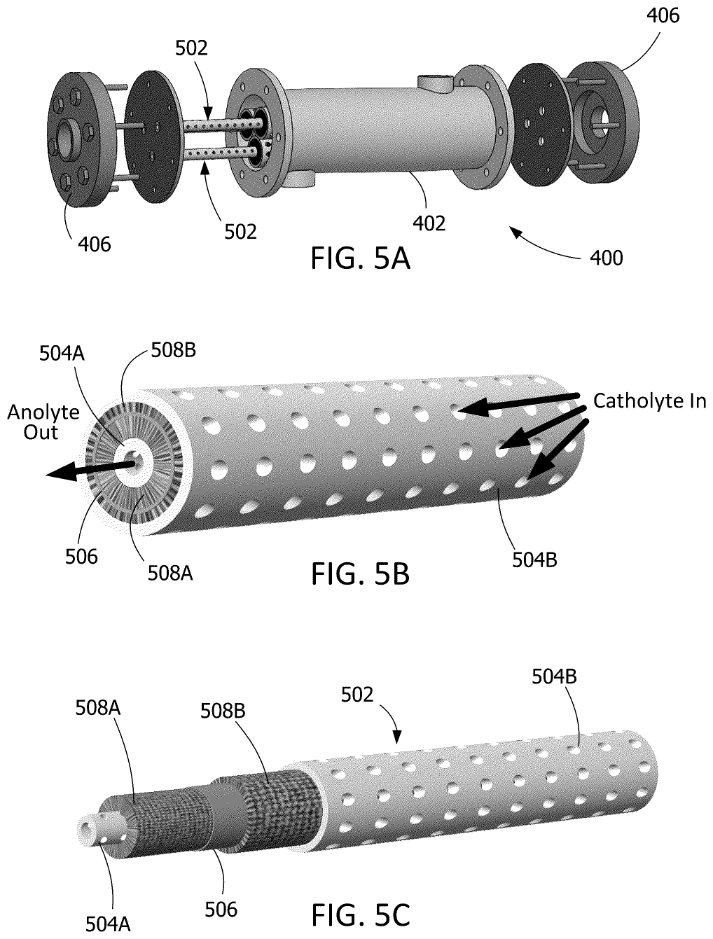

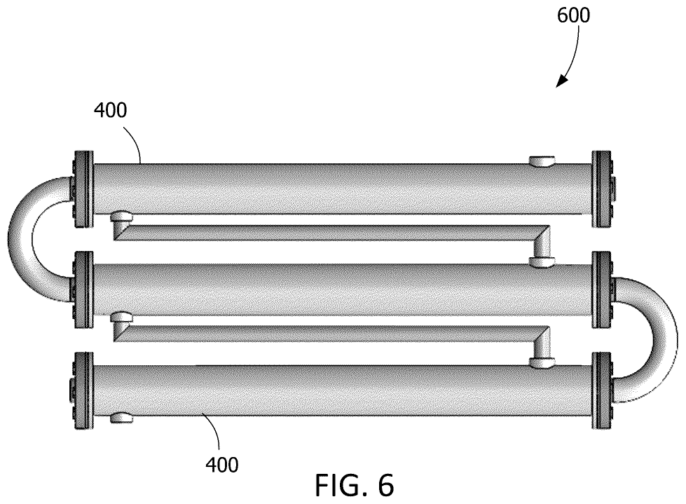

FIG. 4 illustrates a heat-exchanger type flow REFB 400 similar to the flow battery 300 of FIG. 3 in accordance with another embodiment. The conventional flow battery typically features a stacked design, but the REFB 400 embodying aspects of the present disclosure introduces a fundamentally different approach. The REFB 400 is designed to improve electrolyte management, structural reliability, and manufacturing efficiency. The REFB 400 enhances electrolyte distribution and system efficiency through an innovative heat exchanger-inspired structure that differs fundamentally from the conventional stacked designs. The REFB 400 consists of three primary components: an outer chamber 402, one or more inner flow channels (see FIGS. 5A-5C), and membranes (see FIGS. 5A-5C). In an embodiment, the outer chamber 402 is made of tubular polyvinyl chloride (PVC) and has PVC end caps 406. The outer chamber 402 houses a catholyte solution and provides designated inlets and outlets for controlled electrolyte flow. Inside the housing, the inner flow channels contain an anolyte solution.

FIG. 5A is an exploded view of the REFB 400 of FIG. 4 and FIGS. 5B and 5C illustrate its internal components. In one or more embodiments, inner flow channels 502 facilitate efficient anolyte transport. They are each structured using two concentric steel tubes wherein a smaller inner steel tube serves as the anode current collector 504A and a larger outer steel tube acts as a cathode current collector 504B. A membrane layer 506 separates the anolyte from the catholyte and two layers of carbon felt, for example, form an anode electrode 508A and a cathode electrode 508B. In this design, the outer chamber 402, inner flow channels 502, and membrane 506 are carefully structured to optimize ion transport and minimize resistance.

Within this design, as depicted in FIGS. 5A-5C, the smallest unit, i.e., inner flow channels 502, comprises a flow channel with the current collector 504A, anode electrode 508A, membrane 506, cathode electrode 508B, and current collector 504B. Notably, the current collectors 504A, 504B incorporate numerous channels to facilitate the flow into and soaking of the anode/cathode electrodes 508A, 508B, thereby enhancing overall efficiency. Additionally, the gaps between the unit bundles act as conduits for the catholyte flow into the cathode electrode 508B, as illustrated in FIGS. 5A-5C. Indeed, the advantages of REFB 400 extend beyond its innovative design. With its unique configuration, the risk of leaking is minimized thus ensuring a more reliable and durable battery system. Furthermore, the flexible design of REFB 400 allows for easy installation and adaptation to various settings and applications. One of the key strengths lies in its optimized electrolyte flow control, which enhances efficiency and overall performance. These features collectively make REFB 400 a solution for energy storage needs, offering reliability, versatility, and efficiency in a wide range of scenarios.

Referring further to FIG. 5C, the membrane 506 of REFB 400 comprises, for example, sulfonated polyether ether ketone (SPEEK). In an embodiment, membrane 506 is approximately 50 to 100 μm thick and enables efficient proton exchange. The membrane 506 is fabricated by immersing polyether ether ketone tubes in sulfuric acid for controlled sulfonation to enhance their ion transport properties and chemical stability according to an embodiment. Unlike traditional stacked flow batteries, the illustrated heat-exchanger-type structure of REFB 400 optimizes electrolyte flow, reduces leakage risks, and improves durability. Furthermore, the modular nature of REFB 400 allows for flexible installation, including wall-mounted, ceiling-mounted, and structure-embedded configurations, making it adaptable to various energy storage applications.

As described above, the larger outer steel tube functions as the cathode current collector 504B, while the inner steel tube serves as the anode current collector 504A. This arrangement maximizes electrolyte contact with electrodes 508A, 508B, ensuring efficient redox reactions while preventing mixing of anolyte and catholyte solutions. A critical advancement in the system of FIGS. 5A-5C is the use of SPEEK membranes, fabricated through controlled sulfonation of PEEK tubes. These membranes offer superior ion conductivity, chemical stability, and mechanical durability, addressing degradation issues commonly observed in conventional flow batteries.

According to one or more embodiments, the heat-exchanger-type REFB 400 stands apart from conventional flow battery designs and optimizes electrolyte distribution and minimizes leakage risks through a novel flow channel configuration. Unlike traditional stacked designs that often suffer from inefficient flow management and structural limitations, REFB 400 enhances durability and installation versatility, allowing for wall-mounted, ceiling-mounted, or structure-embedded configurations. Another distinguishing factor is the closed-shape membrane synthesis, utilizing extrusion or advanced 3D printing to create tube-like membranes with controlled wall thickness through sulfonation. This approach improves mechanical stability and longevity, addressing common degradation issues found in conventional flat membranes. Additionally, the aspects leverage additive manufacturing for flow battery components, enabling rapid prototyping, complex geometries, and flexible material choices, which traditional fabrication methods cannot achieve. While other research in the field focuses on incremental improvements to existing designs, this approach redefines both the structural and manufacturing aspects of flow batteries, providing a more scalable, adaptable, and cost-effective energy storage solution.

Aspects of the present disclosure permits integrating a heat-exchanger-type flow battery design, such as REFB 400, with a standardized modular assembly, offering significant improvements over conventional flow batteries. FIG. 6 illustrates an example of a modular assembly 600 according to an embodiment in which a plurality of standardized units (i.e., a plurality of standardized REFBs 400) are connected to each other. In an embodiment, standardized units may be categorized into small, medium, and large sizes. These standardized units serve as the building blocks of the modular assembly 600 of FIG. 6. Each unit can be carefully designed to meet specific power requirements and performance criteria. Once defined, these units are assembled into modules, such as modular assembly 600, based on the desired power performance. This modular approach offers several advantages, including scalability, flexibility, and ease of maintenance. Additionally, it allows for efficient customization and adaptation to varying power demands and different energy storage needs., ensuring optimal performance in diverse applications. Unlike traditional stacked flow batteries, which are often limited in installation configurations, the design of REFB 400, as well as that of modular assembly 600, supports wall-mounted, ceiling-mounted, and structure-embedded setups, enhancing adaptability. For seamless structural integration, advanced manufacturing techniques such as 3D printing can be leveraged to incorporate the system directly into infrastructure, expanding its potential applications. The heat-exchanger-type architecture combined with modular scalability provides a more efficient, reliable, and adaptable alternative to existing flow battery designs. This novel system improves electrolyte distribution, minimizes leakage risks, enhances installation flexibility, and enables durable long-term performance, making it a highly promising solution for next-generation energy storage applications.

The assembled modular assembly 600 depicted in FIG. 6 offers versatile installation options, surpassing the constraints of conventional stacked structures. While it can be installed in a manner similar to traditional methods, the present design excels in adaptability, catering to customers' specific requirements. Various flexible installation examples include wall installation (a), ceiling installation (b), and structure-embedded installation (c). This demonstrates the innovative nature of the disclosed approach, which not only enhances functionality but also expands the possibilities for deployment in diverse environments.

As described above, the heat-exchanger type REFB 400 features optimized flow channels and a modular assembly, reducing leakage risks while providing greater flexibility in installation. The closed-shape membrane synthesis utilizes extrusion or advanced 3D printing to fabricate tube-like membranes with precisely controlled wall thickness through sulfonation, ensuring enhanced durability and efficiency. Additionally, additive manufacturing techniques are employed for membrane and component fabrication, enabling complex designs, rapid prototyping, and improved material flexibility, which revolutionizes flow battery production. Together, these advancements establish a novel framework for next-generation flow battery systems with improved efficiency, manufacturability, and adaptability.

In an embodiment, developing and optimizing REFB technology may involve mathematical modeling, fabrication, experimental validation, and optimization strategies to enhance REFB performance. Such a mathematical model considers key design parameters and the application of key governing equations. These equations encompass the continuity equation for mass conservation, Navier-Stokes equations for fluid flow, electrochemical reaction kinetics for electrode processes, transport phenomena equations for species and charge transport, species conservation equations, thermal transport equations, and boundary conditions. The different design parameters on REFB performance may be categorized into three main groups: geometry (e.g., tube diameters and thicknesses, channel size, shape, distribution, membrane thickness), material (including membrane properties and engineering electrode properties), and operational conditions (such as flow rate, operating temperature, voltage window, and current density). By systematically varying these parameters and analyzing their impact on performance metrics such as power density, efficiency, and cycling stability, key design factors that significantly affect REFB performance may be identified. For example, the flow channels in the current collector play a critical role in facilitating fluid flow and maintaining mechanical strength, as indicated by the impact on the pressure drop and voltage response. As the number of channels increases, it leads to a higher voltage response attributed to reduced polarization, while the pressure drop decreases along the main flow path.

Regarding synthesis of membrane 506, sulfonation processes are used to improve ion conductivity rates and ion-selective permeability. Native PEEK tubing may be extruded to achieve the desired tubing size, aiming for smooth interfaces to potentially minimize interfacial impedance. Additionally, 3D printing technology may be employed to enhance manufacturing capability for more complex geometries, aiming to produce printed tubing for RFB or REFB cells while controlling wall thickness and surface area.

3D printing technology with PEEK may be used as an alternative to extrusion for achieving printed tubing, followed by either a sulfonation process or SPEEK polymers. This approach serves two purposes. Firstly, since PEEK can be challenging to extrude with thin walls, a backup option is to 3D print either native PEEK tubing, followed by sulfonation, or tubing from custom-made SPEEK polymer filaments. Secondly, this method enhances manufacturing capacity for more intricate geometries, as illustrated in FIG. 5B. For 3D printing, a fused deposition modeling (FDM) technique incorporating a minimized scaffold printed interior and exterior to support tubing formation may be used.

In an embodiment, the electrodes 508A, 508B of REFB 400 comprises commercial products such as carbon felt (CF) and graphite felt (GF) that are subjected to treatments including thermal processes, chemical etching, and catalyst introduction. Alternatively, electrodes 508A, 508B are formed by electrospinning to craft tailored carbon nanofibers (CNFs) with customizable composition, porous characteristics, and catalyst decoration. These approaches aim to enhance electrochemical activity and improve mass transport within the electrodes 508A, 508B. Furthermore, laser structuring may be employed to produce finely arranged microscopic channel configurations, leading to electrodes 508A, 508B having exceptional performance at high rates, minimal impedance, and outstanding durability over repeated cycles.

Carbon-based electrodes 508A, 508B play a pivotal role in RFBs by enabling energy storage and release through electrochemical reactions. However, further optimization of the electrode properties is desired to enhance performance of REFB 400. Thermal treatment involves subjecting CF/GF electrodes 508A, 508B to controlled heating processes, inducing changes in surface chemistry, morphology, and electrochemical activity. Chemical etching, typically utilizing agents like potassium hydroxide (KOH), creates nanopores on the material's surface, enhancing electrochemical activities and electrolyte utilization rates.

In chemical etching, which involves process of selectively removing material from a surface using a chemical solution like KOH, the focus lies on optimizing etching parameters such as concentration, temperature, and duration to achieve desired pore size and distribution. Introduction of catalysts, including titanium-based compounds like TiO2, TiC, and TiN, improves selectivity of reactions, accelerates reaction rates, and enhances electrochemical activity.

Catalyst decoration is a crucial approach to enhance the performance of REFBs. Through robust integration of metals, metal alloys, carbonaceous materials, and other substances into electrodes via physical or chemical methods, reactions undergo enhanced selectivity, accelerated reaction rates, and heightened electrochemical activity. According to an embodiment, impregnation is used depositing catalysts onto CF/GF surfaces. According to an alternative embodiment, electrodeposition is used for depositing catalysts onto CF/GF surfaces. In impregnation, the electrodes 508A, 508B are immersed in a catalyst precursor solution, where the precursor molecules adsorb onto the surface and are activated through subsequent treatment. Electrodeposition involves immersing the electrodes 508A, 508B in an electrolyte solution containing catalyst precursor ions and applying an electric potential to induce deposition onto the GF surface. For the catalyst, titanium-based compounds (TiO2, TiC) are used because they have shown promising catalytic performance for RFBs. For instance, carbon nanofibers (CNF/TiO2) obtained through electrospinning technology have been applied to negative electrodes in RFBs.

Electrospinning offers an alternative approach for creating tailored materials for RFBs and REFBs. It enables the production of precise nanofiber structures with customizable composition and porous characteristics, addressing key challenges in electrode design. While conventional carbon-based materials used in RFBs lack adequate catalytic activity, electrospun carbon materials provide higher surface area and adjustable microstructure, potentially improving electrochemical performance. By finely adjusting properties like pore volume and surface area, electrospinning can enhance mass transport within RFB and REFB electrodes. Additionally, the decoration of electrospun carbon materials with catalysts further enhances their electrocatalytic activity, boosting overall battery performance.

Well-interbonded carbon nanofibers (CNFs) through a Ni-doping process to enhance battery performance improves electrical conductivity and mechanical strength of electrospun carbon materials. According to one or more embodiments, a semi-interpenetrating (IPN) polymer, polyvinylpyrrolidone (PVP), is electrospun with a polyacrylonitrile (PAN) precursor. This created intermolecular bonding between the nanofibers in the thickness direction, followed by an optimized carbonization process. The hydrophilicity of PVP facilitated the bonding of nanofiber layers during electrospinning, creating interconnections in the thickness direction. Consequently, the semi-IPN PVP induced PAN precursor established both intra- and inter-molecular bonds during high-voltage electrospinning, promoting polymer chain conjugation between PAN and PVP polymers. Numerous interconnections among the nanofibers were observed. After carbonization, improved interbonding was evident, establishing a robust network among the carbon nanofibers. Furthermore, the semi-interpenetrating PVP facilitated the amalgamation of 200 nm diameter fibers into single nanofibers.

In an embodiment, chemical melting deposition (CMD) addresses the limitations of existing techniques such as chemical vapor deposition (CVD) and physical vapor deposition (PVD) for producing nanofiber-nanoparticle composites in large-scale. CMD entails melting carrier fibers neighboring target fibers to facilitate the transfer and anchoring of particles, thereby employing a liquid-based contact technique that amplifies the concentration of active materials in contrast to vapor-based methods. This innovation holds significant value for applications in the energy, chemistry, and biomedicine fields, where a high content of active materials is required. We will utilize this method to decorate catalyst particles onto electrospun nanofibers.

In yet another alternative embodiment, laser structuring of electrodes 508A, 508B provides well-ordered microscopic channel structures to establish a three-dimensional carbon framework. This laser-structured electrode demonstrates exceptional cyclability at high rates, low impedance, and prolonged cycle life, all attributed to a potent synergistic effect. This effect harnesses an expansive electrochemically active surface area, fostering swift electrochemical reactions, and superior transport properties that facilitate the facile movement of species. Moreover, the micro-scale channels formed through laser ablation act as dynamic capillary structures, enabling uniform and rapid wetting of the electrodes.

Aspects of the present disclosure provide numerous benefits over conventional RFB and VRFB design that enhance the performance, reliability, and adaptability of flow battery technology. For instance, the heat-exchanger type REFB 400 having optimized flow channels and modular assembly minimizes leakage risks and offers versatility in installation options. A closed-shape membrane synthesis as described above utilizes extrusion or advanced 3D printing technology to create closed tube-type membranes having controlled wall thickness through sulfonation, which ensures optimal performance and durability. Further improvements involve the use of a soluble Fe anolyte, such as Fe(NTMPA)2, to improve long-term cycling stability and scalability potential. Aspects of the present disclosure further leverage additive manufacturing techniques for membrane and component fabrication, which revolutionizes flow battery manufacturing with complex designs, rapid prototyping, and material flexibility. Moreover, mathematical models for virtual exploration of the design space accelerates innovation and provides valuable insights into system behavior, guiding informed decision-making and design refinement.

One or more embodiments address several key challenges associated with conventional flow battery systems by improving their efficiency, reliability, and scalability. Traditional flow batteries often suffer from stacked structure limitations, leading to increased leakage risks, inefficient electrolyte flow, and constrained installation options. The REFB 400 overcomes these issues with a heat-exchanger-type design that optimizes electrolyte distribution, minimizes leakage, and enhances durability. Additionally, membrane integrity and fabrication complexity are major concerns in conventional systems, where flat membranes may degrade over time due to mechanical stress and uneven ion transport. The closed-shape membrane synthesis in this design ensures better structural stability, controlled wall thickness, and extended operational lifespan. Furthermore, manufacturing constraints in traditional flow batteries limit design flexibility and increase production costs. By incorporating additive manufacturing techniques, aspects of the present disclosure enable rapid prototyping, customized geometries, and efficient material utilization, revolutionizing flow battery production. Overall, this innovation provides a more versatile, durable, and efficient energy storage solution that enhances deployment flexibility and long-term performance.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the disclosure.

When introducing elements of the disclosure or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the disclosure, and describes several embodiments, adaptations, variations, alternatives and uses of the aspects of the disclosure, including what is presently believed to be the best mode of carrying out the aspects of the disclosure. Additionally, it is to be understood that the aspects of the disclosure are not limited in its application to the details of construction and the arrangement of components set forth in the following description or illustrated in the drawings. The aspects of the disclosure are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the disclosure defined in the appended claims. As various changes could be made in the above constructions and methods without departing from the scope of the disclosure, it is intended that all matter contained in the above description and shown in the accompanying drawings shall be interpreted as illustrative and not in a limiting sense.

In view of the above, it will be seen that several advantages of the aspects of the disclosure are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. An electrochemical reaction cell assembly comprising:
a housing;
at least one tubular cell unit positioned within the housing, the tubular cell unit comprising:
an inner current collector and an outer current collector arranged concentrically with respect to the each other within the tubular cell unit;
first and second electrodes positioned between the inner current collector and the outer current collector; and
a membrane separating the first and second electrodes from each other;
first and second electrolyte fluids contained within the housing and in contact with each other at the membrane of the tubular cell unit; the first electrolyte fluid having oppositely charged ions relative to the second electrolyte fluid, the first electrolyte fluid in contact with the first electrode, and the second electrolyte fluid in contact with the second electrode.

2. The electrochemical reaction cell assembly of claim 1, wherein the first electrolyte fluid comprises a catholyte and the first electrode comprises a cathode, and wherein the second electrolyte fluid comprises an anolyte and the second electrode comprises an anode.

3. The electrochemical reaction cell assembly of claim 2, wherein the inner current collector of the tubular cell unit defines an inner flow channel through which the anolyte flows, and wherein the catholyte flows within the housing around the tubular cell unit.

4. The electrochemical reaction cell assembly of claim 2, wherein the anolyte comprises a soluble iron anolyte.

5. The electrochemical reaction cell assembly of claim 4, wherein the soluble iron anolyte comprises Fe(NTMPA)2.

6. The electrochemical reaction cell assembly of claim 1, wherein the inner current collector and the outer current collector both comprise tubes having a plurality of perforations formed therein.

7. The electrochemical reaction cell assembly of claim 6, wherein which the first electrolyte fluid is transferred to the first electrode and to the membrane via the perforations in the outer current collector.

8. The electrochemical reaction cell assembly of claim 6, wherein which the second electrolyte fluid is transferred to the second electrode and to the membrane via the perforations in the inner current collector.

9. The electrochemical reaction cell assembly of claim 1, wherein the housing comprises a first inlet through which the first electrolyte fluid enters the housing and a first outlet through which the first electrolyte fluid exits the housing, and wherein the housing comprises a second inlet through which the second electrolyte fluid enters the housing and a second outlet through which the second electrolyte fluid exits the housing.

10. The electrochemical reaction cell assembly of claim 1, wherein the first and second electrodes comprise at least one of a carbon felt or a graphite felt.

11. The electrochemical reaction cell assembly of claim 10, wherein the first and second electrodes each undergo at least one of a thermal treatment, chemical etching, or catalyst decoration.

12. The electrochemical reaction cell assembly of claim 1, wherein the first and second electrodes are formed by an electrospinning process.

13. The electrochemical reaction cell assembly of claim 1, wherein the membrane comprises a tubular sulfonated polyether ether ketone.

14. The electrochemical reaction cell assembly of claim 1, wherein the assembly comprises a flow battery.

15. A multi-cell assembly comprising:
a plurality of redox exchange flow batteries, each comprising:
a tubular housing; and
at least one tubular cell unit positioned within the housing, the tubular cell unit comprising:
an inner current collector and an outer current collector arranged concentrically with respect to the each other within the tubular cell unit;
an anode and a cathode positioned between the inner current collector and the outer current collector; and
a membrane separating the anode and the cathode from each other;
a catholyte fluid contained within the housing and in contact with the cathode; and
an anolyte fluid contained within the housing and in contact with the anode;
wherein the inner current collector of the tubular cell unit defines an inner flow channel through which the anolyte fluid flows in contact with the anode, and
wherein the catholyte fluid flows within the housing around the tubular cell unit in contact with the cathode.

16. The multi-cell assembly of claim 15, wherein the anolyte comprises a soluble iron anolyte.

17. The multi-cell assembly of claim 16, wherein the soluble iron anolyte comprises Fe(NTMPA)2.

18. The multi-cell assembly of claim 15, wherein the inner current collector and the outer current collector both comprise tubes having a plurality of perforations formed therein.

19. The multi-cell assembly of claim 18, wherein the catholyte fluid is transferred to the cathode and to the membrane via the perforations in the outer current collector, and wherein the anolyte fluid is transferred to the anode and to the membrane via the perforations in the inner current collector.

20. The multi-cell assembly of claim 15, wherein the housing comprises a first inlet through which the catholyte fluid enters the housing and a first outlet through which the catholyte fluid exits the housing, wherein the housing comprises a second inlet through which the anolyte fluid enters the housing and a second outlet through which the anolyte fluid exits the housing, and wherein the first and second outlets are in fluid communication with another one of the plurality of redox exchange flow batteries via corresponding first and second inlets thereof.

21. The multi-cell assembly of claim 15, wherein the cathode and the anode comprise at least one of a carbon felt, a graphite felt, or an electrospun carbon material.

22. The multi-cell assembly of claim 15, wherein the membrane comprises a tubular sulfonated polyether ether ketone.
